(19) United States
(12) Patent Application Publication
(10) Pub. No.: US 2025/0227255 A1
(43) Pub. Date: Jul. 10, 2025

(54) SYSTEMS AND METHODS FOR OBJECT BOUNDARY MERGING, SPLITTING, TRANSFORMATION AND BACKGROUND PROCESSING IN VIDEO PACKING

(71) Applicant: OP Solutions LLC, Amherst, MA (US)

(72) Inventors: Hari Kalva, Boca Raton, FL (US); Borivoje Furht, Boca Raton, FL (US); Velibor Adzic, Canton, GA (US); Alena Krause, Coconut Creek, FL (US); Md Eimran Hossain EIMON, Boca Raton, FL (US); Ashan Perera, Boca Raton, FL (US)

(73) Assignee: OP Solutions LLC, Amherst, MA (US)

(21) Appl. No.: 19/089,979

(22) Filed: Mar. 25, 2025

Related U.S. Application Data
(63) Continuation of application No. PCT/US2023/033824, filed on Sep. 27, 2023.
(60) Provisional application No. 63/410,251, filed on Sep. 27, 2022.
(60) Provisional application No. 63/410,266, filed on Sep. 27, 2022.
(60) Provisional application No. 63/410,272, filed on Sep. 27, 2022.
(60) Provisional application No. 63/415,376, filed on Oct. 12, 2022.

(51) Int. Cl. H04N 19/167; H04N 19/169

(52) U.S. Cl. CPC H04N 19/167; H04N 19/188

(57) ABSTRACT

Systems and methods for encoding and decoding video content for machine consumption with enhanced region packing strategies. An encoder includes a region detector module which receives a source video and identifies regions of interest therein. A top-down region extractor module receives the identified regions of interest and generates modified set of regions of interest that can be packed in a frame more efficiently. A region packing module receives the modified set of regions of interest and arranges the modified set of regions of interest into a packed frame in which pixels outside the modified regions of interest are substantially excluded. A video encoder encodes the packed frame and region parameters into a coded bitstream. A decoder provides complimentary processing to reconstruct a frame with the regions of interest arranged as they were in the source frame.

### CROSS-REFERENCE TO RELATED APPLICATIONS

The present application is a continuation of international application PCT/US2023/033824 filed on Sep. 27, 2023, and entitled SYSTEMS AND METHODS FOR OBJECT BOUNDARY MERGING, SPLITTING, TRANSFORMATION AND BACKGROUND PROCESSING IN VIDEO PACKING, which application claims the benefit of priority to U.S. Provisional Application Ser. No. 63/410,251 filed on Sep. 27, 2022, and entitled System and Method for Top-Down Object Boundary Merging and Splitting in Video Packing, and also claims the benefit of priority of U.S. Provisional Application Ser. No. 63/410,266 filed on Sep. 27, 2022, and entitled “Systems and Methods for Region Transformations in Video Box Packing,” and further claims the benefit of priority of U.S. Provisional Application Ser. No. 63/410,272 filed on Sep. 27, 2022, and entitled “Systems and Methods for Adaptive Frame Reconstruction for Video Region Packing,” and further claims the benefit of priority to U.S. Provisional Application Ser. No. 63/415,376, filed on Oct. 12, 2022, and entitled “Systems and Methods for Video Packing, Encoding and Decoding for Machine-based Applications,” the disclosures of each which are hereby incorporated by reference in their entireties.

### FIELD OF THE DISCLOSURE

The present disclosure generally relates to the field of video encoding and decoding. In particular, the present disclosure is directed to coding and decoding of video for machines.

### BACKGROUND OF THE DISCLOSURE

Recent trends in robotics, surveillance, monitoring, Internet of Things, etc. introduced use cases in which a significant portion of all the images and videos that are recorded in the field is consumed by machines only, without ever reaching human eyes. Those machines process images and videos with the goal of completing tasks such as object detection, object tracking, segmentation, event detection etc. Recognizing that this trend is prevalent and will only accelerate in the future, international standardization bodies established efforts to standardize image and video coding that is primarily optimized for machine consumption. For example, standards like JPEG AI and Video Coding for Machines are initiated in addition to already established standards such as Compact Descriptors for Visual Search, and Compact Descriptors for Video Analytics. Solutions that improve efficiency compared to the classical image and video coding techniques are needed. One such solution is presented here.

### SUMMARY OF THE DISCLOSURE

In one embodiment, an encoder for video for machine consumption is provided that includes a region detector module which receives a source video and identifies regions of interest therein. A top-down region extractor module receives the identified regions of interest and generates modified set of regions of interest that can be packed in a frame more efficiently, the modified regions of interest being defined at least in part by region parameters. A region packing module receives the modified set of regions of interest and arranges the modified set of regions of interest into a packed frame in which pixels outside the modified regions of interest are substantially excluded. A video encoder receives the packed frame and region parameters and encodes the packed frame and region parameters into a coded bitstream.

The regions of interest may be defined by a bounding box, such as a rectangular bounding box, and the region parameters can include coordinates of the region bounding box within the source video frame.

The top-down region extractor module may further provide processing of the detected regions of interest to form a union of regions of interest where at least one of adjacent and overlapping regions of interest are combined. In some embodiments, processing further includes aligning the regions of interest from the union process to a predetermined grid, slicing the aligned regions of interest along grid partitions, and reattaching slices to form modified regions of interest. The top-down region extractor module can then provide coordinates of the modified regions of interest.

In certain embodiments, the predetermined grid is selected to align the regions of interest with boundaries of a coding tree unit in the packed frame. In some embodiments, the predetermined grid is a 16×16 pixel grid.

In addition, the encoder may include a region transform module interposed between the top-down region extractor module and the region packing module, the region transform module, the region transform module receives the coordinates of the modified regions of interest and applies at least one transform from the group including scaling, rotation, and translation on at least one modified region of interest, and provides coordinates of the transformed modified region of interest. In some embodiments, the region transform module receives adaptive transformation parameters related to a machine process and applies a selected transform based in part on those parameters. In yet another embodiment, the region transform module applies a transform based on at least one characteristic of the region of interest including object confidence, object class, region area, or coding unit parameters.

In another embodiment, an encoder for encoding video for machine consumption includes a region detector module receiving the source video and identifying regions of interest therein which are defined in part by coordinates of a bounding box in the frame of source video. A region transform module receives the coordinates of the regions of interest and applies at least one transform from the group including scaling, rotation, and translation on at least one modified region of interest, to improve region packing efficiency and provides coordinates of the transformed modified region of interest. A region packing module receives the set of regions of interest and transformed regions of interest and arranges the regions of interest into a packed frame in which pixels outside the regions of interest are substantially excluded. A video encoder receives the packed frame and coordinates of the regions of interest and encodes the packed frame and region parameters into a coded bitstream.

A method for encoding a source video for machine consumption is also provided. The method preferably includes receiving the source video and identifying regions of interest therein. The detected regions of interest may be processed to form a union of regions of interest where at least one of adjacent and overlapping regions of interest are combined. The method further includes aligning the regions of interest from the union process to a predetermined grid, slicing the aligned regions of interest along grid partitions, and reattaching slices to form modified regions of interest. Coordinates of the modified regions of interest are provided and the modified regions of interest are arranged into a packed frame in which pixels outside the modified regions of interest are substantially excluded. The packed frame and region parameters, including the coordinates to the modified regions, are encoded in a coded bitstream.

Decoders and decoding methods are provided. Preferably, a decoder is configured to receive an encoded bitstream encoded by any of the encoders and encoding methods described herein and comprising circuitry configured to decode the bitstream and reconstruct a frame with regions of interest from a source video while excluding pixels outside the regions of interest.

In one embodiment, a decoder for decoding an encoded bitstream having a packed frame of regions of interest, features enhanced processing of background pixels. The decoder includes a video decoder receiving the encoded bitstream and decompressing the bitstream to identify regions of interest and region parameters therefrom. A region unpacking module receives the decoded packed frame and region parameters and arranges the decoded regions of interest in a reconstructed frame with size, position and orientation corresponding to the original frame. Pixels in the reconstructed frame outside the arranged regions of interest are considered background pixels. A background processing module is provided and sets a parameter of the background pixels to optimize performance of a machine task system receiving the reconstructed frame.

In some embodiments, the background processing module receives at least one adaptive fill parameter indicating a performance metric of the machine task system based on at least one parameter of the background pixels. The parameter of the background pixels may be a fixed color or an average color of the pixels in the regions of interest. In some cases, the adaptive fill parameter indicates a parameter of the background pixels in which object detection by the machine task system is optimized.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE FIGURES

FIG. 1 is a simplified block diagram of a system for encoding and decoding video for machines, such as in a system for Video Coding for Machines (VCM).

FIG. 2 is a simplified block diagram of a system for encoding and decoding video for machines, such as Video Coding for Machines (“VCM”), with region packing with top-down region extraction in accordance with the present disclosure.

FIG. 3 is a block diagram illustrating the structure and operation of a top-down region extractor in accordance with the present disclosure.

FIG. 4A is a pictorial representation of an exemplary image with inference predictions as input to the top-down region extractor of FIG. 3.

FIG. 4B illustrates the union of inference predictions generated in process 308 in FIG. 3.

FIG. 4C illustrates the union of inference predictions of FIG. 4B transformed into a 16×16 grid alignment in the polygon transform process 312 in FIG. 3.

FIG. 4D illustrates the bounding boxes of aligned polygons from further processing of the polygon transform process in FIG. 3.

FIG. 4E illustrates the bounding boxes of FIG. 4D following region splitting process 316 in FIG. 3.

FIG. 4F illustrates the original image with processed inferences following a reattached slices process 320.

FIG. 5 is a simplified block diagram of a system for encoding and decoding video for machines, such as Video Coding for Machines (“VCM”), with region packing in accordance with the present methods.

FIGS. 6A and 6B are a pictorial diagram illustrating an example of region packed frames without and with applied transformations, respectively, in accordance with the present systems and methods.

FIG. 7 is a simplified block diagram of an alternate embodiment of a decoder video for machines, such as Video Coding for Machines (“VCM”), for decoding a bitstream with region packing in accordance with the present methods.

FIG. 8A is a pictorial diagram illustrating and example of unpacked frames with black background and FIG. 8B is the same pictorial diagram with an “average” background in accordance with the present systems and methods.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DESCRIPTION OF EMBODIMENTS

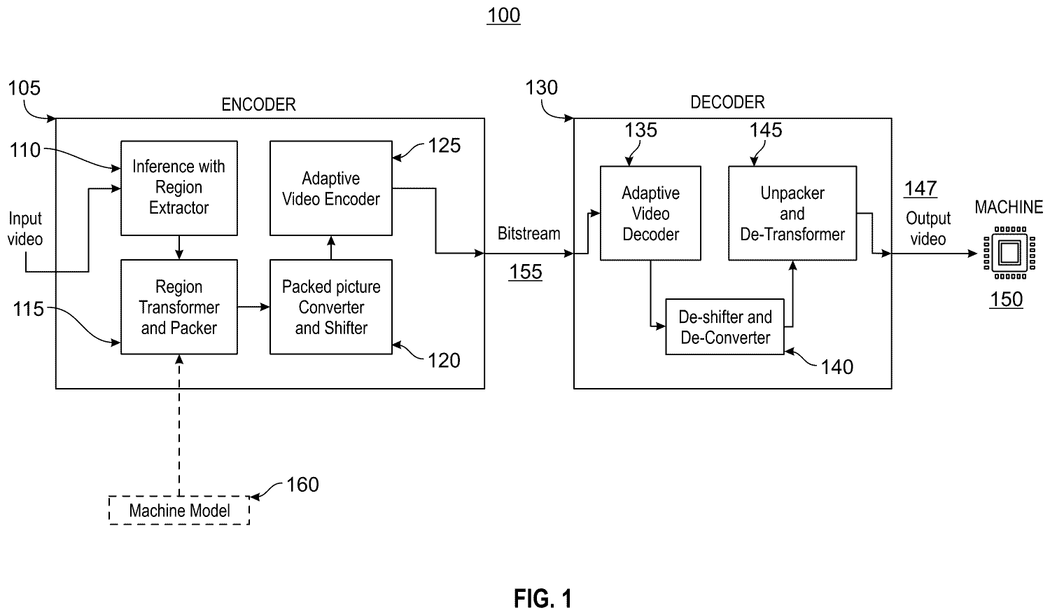

FIG. 1 is a block diagram illustrating an exemplary embodiment of a system comprising of an encoder, a decoder, and a bitstream well suitable for machine-based consumption of video, such as contemplated in applications for Video Coding for Machines (“VCM”). While FIG. 1 has been simplified to depict the components used in coding for machine consumption, it will be appreciated that the present systems and methods are applicable to hybrid systems which also encode, transmit and decode video for human consumption as well. Such systems for encoding/decoding video for various protocols, such as HEVC, VVC, AV1 and the like are generally known in the art.

Referring now to FIG. 1, an exemplary embodiment of a coding system 100 comprising of an encoder 105 which generates an encoded bitstream 155 that is transmitted over a communication channel to a decoder 130 is illustrated.

Further referring to FIG. 1, encoder 105 may be implemented using any circuitry including without limitation digital and/or analog circuitry; encoder 105 may be configured using hardware configuration, software configuration, firmware configuration, and/or any combination thereof. Encoder 105 may be implemented as a computing device and/or as a component of a computing device, which may include without limitation any computing device as described below.

Encoder 105 may include, without limitation, an inference with region extractor 110 module, a region transformer and packer 115 module, a packed picture converter and shifter module 120, and/or an adaptive video encoder module 125.

Further referring to FIG. 1, adaptive video encoder 125 may be a standard encoder for generating a bitstream compliant with known CODEC standards such as HEVC, AV1, VVC and the like, and may include, without limitation, any video encoder as described in further detail below.

Still referring to FIG. 1, and exemplary embodiment of decoder 130 is illustrated. Decoder 130 may be implemented using any circuitry including without limitation digital and/or analog circuitry; decoder 130 may be configured using hardware configuration, software configuration, firmware configuration, and/or any combination thereof. Decoder 130 may be implemented as a computing device and/or as a component of a computing device, which may include without limitation any computing device as described below. In an embodiment, Decoder 130 may be configured to receive an encoded bitstream 155 and generate an output video 147 suitable for machine consumption and/or a video for human consumption in a hybrid system. Reception of a bitstream 155 may be accomplished in any manner described below. A bitstream may include, without limitation, any bitstream as described below. The present systems and methods are not limited to a particular CODEC standard and are applicable to current standards such as AV1, HEVC, VVC and the like and variants and improvements thereto. It will be appreciated that the specific structure and operation of the encoder 105 and decoder 130 will depend, in part, on the specific encoding standard used in the deployed system and such encoder and decoders are known in the art.

With continued reference to FIG. 1, a machine model 160 may be present in the encoder 105, or otherwise provided to the encoder 105 in an online or offline mode using an available communication channel. Machine model 160 is application/task specific and generally contains information sufficient to describe requirements for task completion by machine 150. Machine 150 may provide periodic updates to the machine model based on system updates or data related to processing performance. This information can be used by the encoder 105, and in some embodiments specifically by the region transformer and packer 115.

Given a frame of a video or an image, effective compression of such media for machine consumption can be achieved by detecting and extracting its important regions and packing them into a single frame. Simultaneously, the system discards any detected regions that are not of interest. These packed frames then serve as input to an encoder to produce a compressed bitstream. The produced bitstream 155 contains the encoded packed regions along with parameters needed to reconstruct and reposition each region in the original position within the decoded frame. A machine task system can perform tasks such as designated computer vision related functions on the reconstructed video frames.

The present method for video coding for machine consumption is a region-based system that partitions input images into regions of interest that are retained in the encoded bitstream and regions that are not of interest and are discarded at the encoder. Such a video compression system can be improved by applying post-inference region extraction techniques described herein to create new region boxes. These new regions may be derived from the boxes output from the region detection module. Some extraction modules may perform this type of post-processing on a per-box basis; however, the improved systems and methods described herein processes the predictions in a top-down approach. This processing step can eliminate the occurrences of repeated pixels within the region image and may also give more object context which is often beneficial to the endpoint machine task performance.

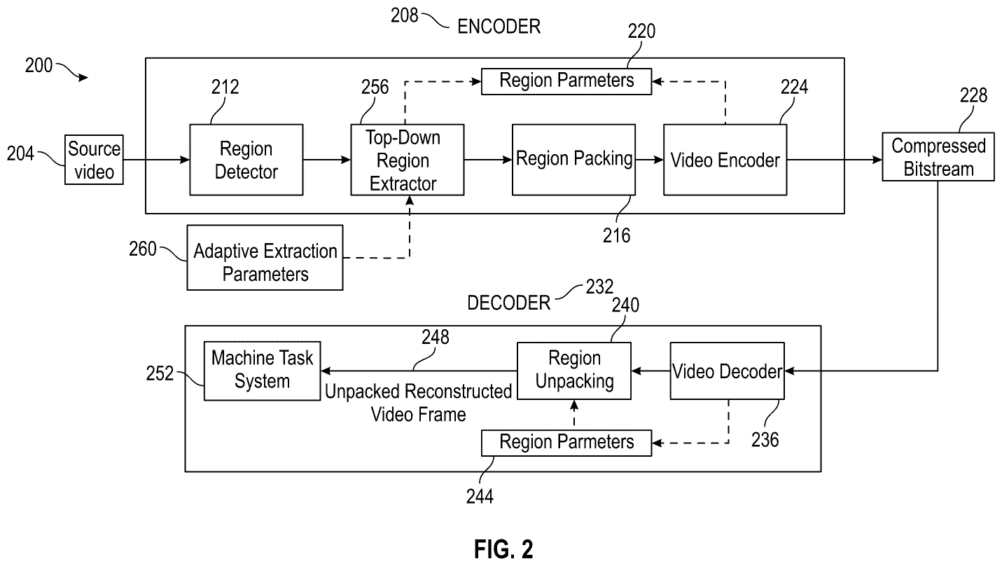

FIG. 2 is a simplified block diagram for a system for region packing in accordance with the present disclosure which shows the proposed CODEC system 200, comprised of an encoder 208 and decoder 232. The encoder includes a region detector module 212 which receives the source video 204 and identifies objects and/or regions of interest therein. The encoder further includes top-down region extractor module 256, region packing module 216, region parameters module 220, and video encoder 224 which cooperate to generate a compressed bitstream 228. Preferably, adaptive extraction parameters 260 are provided to the top-down region extractor 256.

The decoder 232 includes a video decoder 236 which receives the compressed bitstream 228, region unpacking module 240, and region parameters module 244 which cooperate to decode the bitstream and generate unpacked reconstructed video frames 248 for the machine task system 252.

### Region Detection

Significant frame or image regions are identified using the encoder side region detector module 212, which produces coordinates of discovered objects. Typically, the regions are defined, at least in part by a bounding box and the coordinates are vertices of the bounding box. The bounding box may be rectangular and can be defined in any manner sufficient to recreate the region of interest in the original frame, for example, by the coordinates of one corner along with a width and height of the bounding box, the coordinates of diagonally opposed corners, and the like. The region detector module may also output class information as well as confidence scores for each of the identified objects. In one embodiment, a Yolov7 Object Detection Neural Network can be used with a 0.0 confidence threshold. Identified object coordinates can be extended with region padding to give additional context for each of the detections. Padding inference objects may improve endpoint machine task performance. In one example, inference boundaries can be extended by 15-pixels in both dimensions. It will be appreciated, however, that other region padding strategies may be employed including dynamic region padding wherein the amount of padding in each dimension of the bounding box may depend on criteria such as object type or region size.

Saliency based detection methods using video motion may also be employed to identify regions of interest. For example, uniform motion that is detected across consecutive frames can be designated as salient. In another example, any motion that persists over long periods of time (for example 100 frames) in a continuous trajectory can be designated as salient. In another example, motion that is detected at the same coordinates at which the objects are detected can be designated as salient. Spatial coordinates of salient regions are used to determine regions for packing and enable the identification of pixels considered to be unimportant to the detection module. Such unimportant regions may be discarded and are not used in packing.

### Top-Down Region Extraction

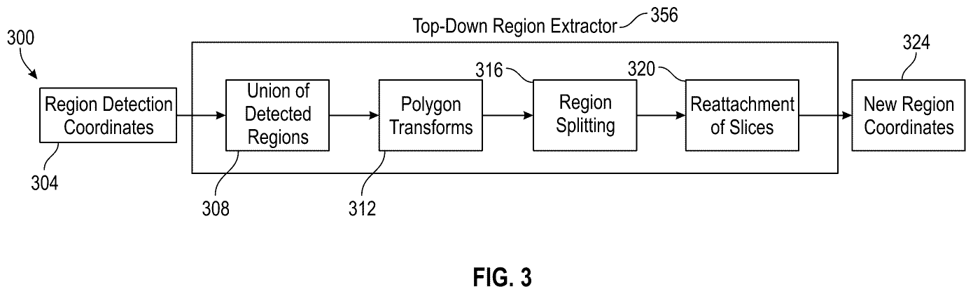

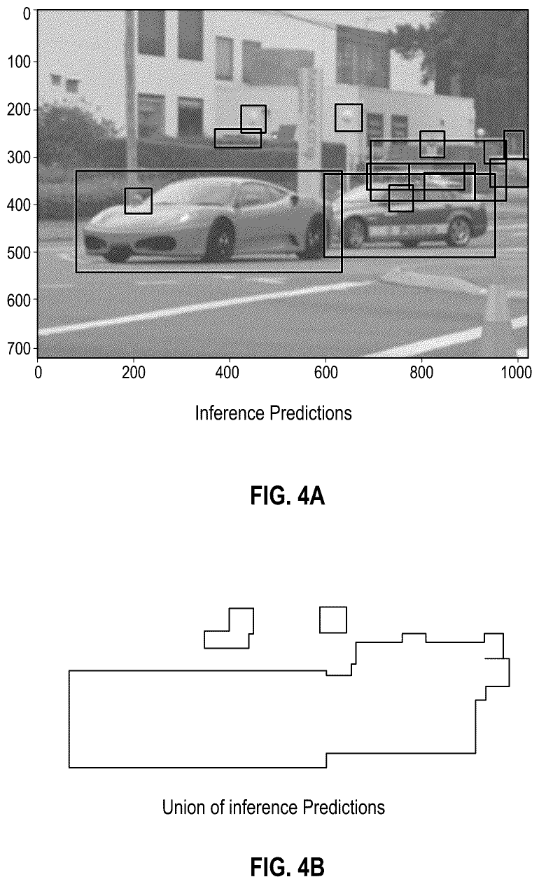

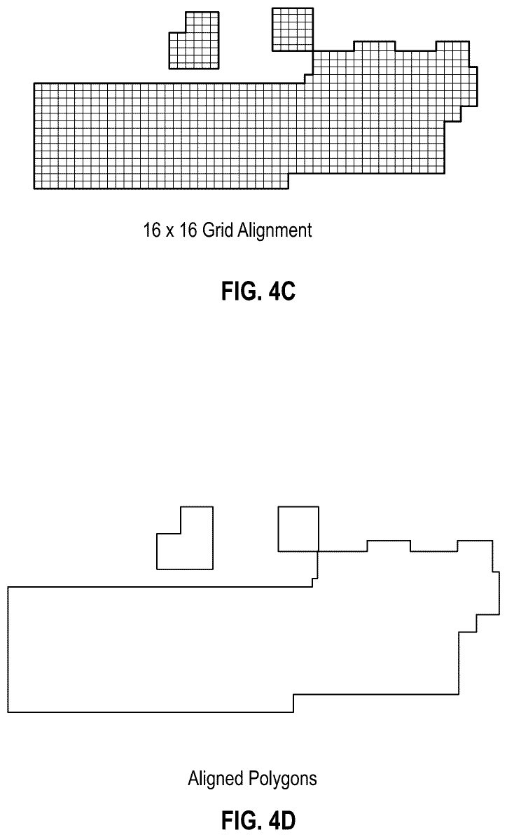

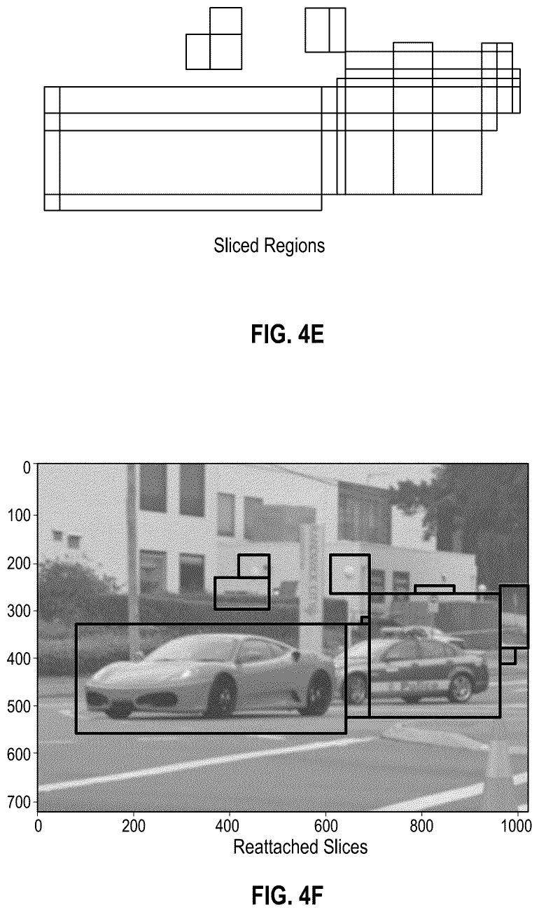

The structure and operation of the top-down region extractor module 256 is further illustrated in FIG. 3. Referring to FIG. 3, the top-down region extractor module operates to provide a union of detected regions 308 as depicted in FIG. 4B, perform polygon transformation on the regions 312 as depicted in FIGS. 4C and 4D, perform region splitting 316 and perform reattachment of slices 320 as illustrated in FIGS. 4E and 4F.

The top-down region extractor module 256 receives object coordinates from region detector module 212. The top-down region extractor module 256 examines the predictions in a top-down approach by unifying all region detections into one or more polygons. Dependent upon overlapping occurrences, a union of inference predictions 308 is taken to create new region polygons. These new region polygons may be of irregular shapes and thus require further processing in order to serve as input to the packing module 216 in FIG. 2.

Unified inference prediction regions identified in 308 may be extended by the polygon transformation module 312 to reduce the number of irregular edges (i.e., vertices that are outside of the overall rectangular bounding coordinates) as illustrated in FIG. 4C. For example, a polygon region may use a 16×16 grid to pad and extend the unified inference regions. Aligning to such a 16×16 grid may also result in better alignment with the coding units of a video encoder, such as coding tree unit (CTU) in the later encoding stages, namely for video encoder module 224. This alignment may improve compression efficiency since the prediction and residual coding is done within the coding block boundaries for each block. The alignment is further disclosed in PCT application PCT/US22/47829 filed on Oct. 26, 2022, and entitled “Systems and Methods for Object and Event Detection and Feature Based Rate Distortion for Video Coding,” the disclosure of which is hereby incorporated by reference in its entirety.

The resulting transformed polygons from polygon transformation module 312 may be split into rectangular sub-boxes as illustrated in FIG. 4E. The division performed by region splitting module 316 is done by slicing the input polygons based on the non-rectangular vertices. That is, the vertices which reside outside of the minimum and maximum x y coordinates are used as reference points for slicing. Vertical and horizontal lines are drawn from the reference points outward to meet the edges of the polygon. These lines form the new bounds of the sliced regions. Resulting fragments may be processed directly by the region packing system or may endure additional processing.

Sliced regions may be greedily and recursively reattached based on shared edges by the reattachment module 320, to create better boxes for packing. Reattachment can be performed by merging two boxes with shared edges to form a new region. This reattachment is considered “greedy” as it may consider characteristics of box regions to determine the order in which the regions are processed. For example, sliced regions can be sorted by area, class, and confidence in order to prioritize reattachment of certain boxes over others. In some instances, boxes with larger areas being reattached first may help to preserve region characteristics. Similarly, reattaching based on confidence can help to better preserve objects with high inference scores. Reattaching the boxes may help with reducing the number of rectangles sent to the packing module 216 and overall helps with spatial preservation providing more context for the endpoint machine task system 252. FIG. 4F illustrates an example of the sample image of FIG. 4A with reattached slices forming the new regions of interest.

FIGS. 4A-4F illustrate a pictorial example of the Top-Down Region Extractor process. FIG. 4A illustrates an image with inference predictions therein. The union of the detected inference coordinates from block 308 is illustrated in FIG. 4B. A 16×16 grid is then used to apply padding and alignment to the polygon region in 312 further illustrated in FIG. 4C. The resulting shape in FIG. 4D may be split by module 316 (FIG. 4E), with reattachment performed by the reattachment module 320 as shown in FIG. 4F. Final coordinates are overlayed on the source image in 324.

Table 1 compares the top-down region extraction method to a per-object merge-split region extraction method. The merge-split method considers occurrences of overlapping predictions to be either merged together or divided into separate smaller regions on a per-prediction basis. From the results, the top-down approach yields more effective bit reduction and additionally maintains higher machine-task performance. Such an approach provides better regions for packing and consequently boosts overall pipeline efficiency.

TABLE 1
Top-Down Region Extraction
100% Resolution

| | Merge Split Region Extractor | | Top-Down Region Extractor | | Original | |
|---|---|---|---|---|---|---|
| | With Region Packing | | With Region Packing | | Raw Source Frames | |
| QP | BPP | mAP | BPP | mAP | BPP | mAP |
| 22 | 0.630875506 | 0.799955 | 0.620759418 | 0.80147 | 0.841 | 0.80536 |
| 27 | 0.369386636 | 0.792915 | 0.364342718 | 0.795638 | 0.493 | 0.80197 |
| 32 | 0.209926081 | 0.777846 | 0.206152411 | 0.781394 | 0.277 | 0.78775 |
| 37 | 0.115887591 | 0.744664 | 0.112577631 | 0.749274 | 0.147 | 0.75653 |
| 42 | 0.061649195 | 0.679649 | 0.059212221 | 0.687059 | 0.074 | 0.69917 |
| 47 | 0.031508543 | 0.553973 | 0.029979605 | 0.566119 | 0.036 | 0.57773 |

| BD-rate | BD-mAP | BD-rate | BD-mAP |
|---|---|---|---|
| −1.73% | 0.15944 | −11.12% | 0.901351 |

### Region Packing

The newly identified region box coordinates 324, returned from the extraction module 356, serve as input to the region packing module 216. The region packing module 216 extracts the regions of interest and packs them tightly into a single frame. The region packing module 216 produces packing parameters that are preferably signaled later in bitstream 228.

### Video Encoding

Referring to FIG. 2, packed object frames which contain the processed regions from top-down region extractor 256 are input to video encoder 224 which produces a compressed bitstream 228. It will be appreciated that video encoder 224 can take the form of any suitable encoder known in the art for advanced compression standards such as AV1, HEVC, VVC, and the like and/or variants thereof. The compressed bitstream 228 generally includes the encoded packed regions along with parameters 220 needed to reconstruct and reposition each region in the decoded frame. Optionally, original region coordinates (i.e., those derived from region detector module 212, prior to top-down region extraction 256, may be signaled in bitstream for decoder side usage. Signaling may include providing data in a bitstream header, SPS, PPS, or supplemental information, such as SEI, and may vary depending on the CODEC standard in which the present systems and methods are deployed.

### Video Decoding

The compressed bitstream 228 is decoded using video decoder 236 to produce a packed region frame along with its signaled region information 244. Such region information preferably includes parameters sufficient for reconstruction of the frame and may incorporate the original object coordinate information from region detector 212 along with the region information identified in top-down region extractor 256.

### Region Unpacking

The decoded parameters 244 are used to unpack the packed region frames via the region unpacking module 240. Each box is preferably returned to its position within the context of the original video frame. The resulting unpacked frame includes the detected regions of interest placed in their original position in the frame prior to packing and only includes the significant regions determined by the region detection system 212 after extractor module 256 and preferably does not include the pixels outside the regions of interest.

### Machine Task

The unpacked and reconstructed video frame 248 is used as input to machine task system 252 which may perform machine tasks such as computer vision related functions. Machine task performance on the regions determined by the top-down region extractor 156 merge split extraction module may be analyzed to determine optimal extraction actions. Optimized region extraction parameters 260 may be updated and signaled to the encoder side pipeline in order to effectively unify and split prediction regions.

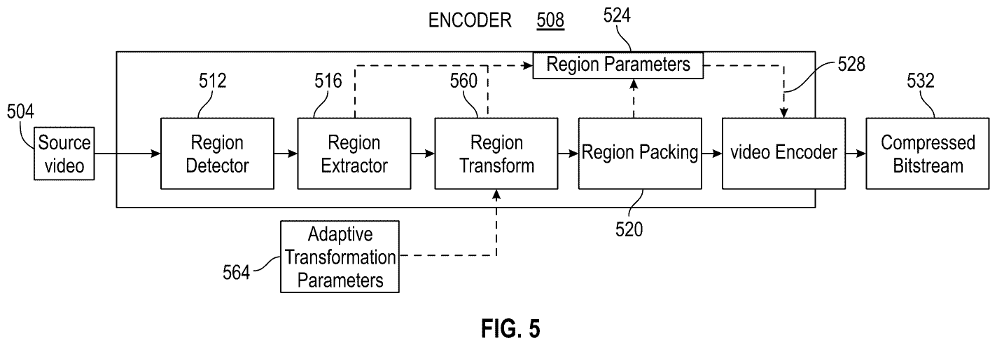

FIG. 5 is a simplified block diagram for an alternate embodiment of an encoder with region packing in accordance with the present disclosure. The encoder 508 includes region detection block 512 which receives the source video 504 and identifies regions of interest therein. The encoder further includes region extractor module 516, region transform module 560, region packing module 520, region parameters 524, and video encoder 528 to generate a compressed bitstream 532. Adaptive transformation parameters 564 are preferably provided to the region transform module 560.

### Region Detection and Extraction

Significant frame or image regions are identified using the encoder side region detector module 512. The regions of interest are typically defined by a boundary box, such as a rectangular bounding box and region detector module 512 produces coordinates of the bounding boxes. Saliency based detection methods using video motion may also be employed to identify important regions. For example, uniform motion that is detected across consecutive frames can be designated as salient. In another example, any motion that persists over long periods of time (for example 100 frames) in a continuous trajectory can be designated as salient. In another example, motion that is detected at the same coordinates at which the objects are detected can be designated as salient. Spatial coordinates of salient regions are used to determine regions for packing and enable the identification of pixels deemed as unimportant to the detection module. Such unimportant regions may be discarded and are not used in packing. The extraction module 516 extracts the image regions identified by region detector module 512 and prepares the coordinates to be used through the rest of the pipeline.

### Region Transformation

The region transformation module 560 receives object coordinates from region extractor module 516. The region transformation module 560 may adaptively apply transformations such as scaling, rotation, and/or translation on a per-region basis. Internal decisions made within the module may use confidence-based, class-based, area-based, or coding unit-based methods to apply these actions.

Transformations are applied with the goal of reducing the bitrate budget needed to encode the frames containing transformed regions. In some cases, transformations can be applied for the benefit of improved detection accuracy on the machine.

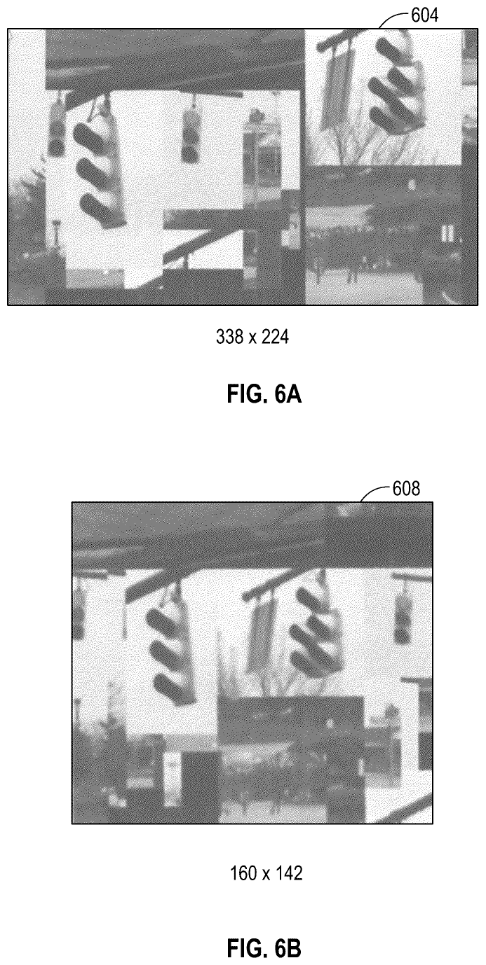

FIG. 6A shows a sample packed region frame without applied transformations and FIG. 6B illustrates the same frame with applied transformations. FIG. 6B illustrates that the applied transformations not only reduce overall frame dimensions, in this example from 338×224 pixels to 160×142 pixels, but may additionally impact and improve packing arrangements.

A class-based transformation may consider the categories of objects which quickly drop in machine task performance metrics when scaling is applied. That is, of the classes of objects present in a video frame, the module shall consider which of the objects can be scaled and by how much. Adaptive transform parameters 564 can be used to indicate the classes of objects that may be scaled along with the classes of objects that should be preserved in size. This may be based, in whole or in part, on performance metrics from the machine task system 252. Detected objects from region detector 512 within the extracted regions can be used to identify which classes are present in each of the regions.

Input transform parameters 564 may be determined by examining machine task performance across different scaling factors on a per class basis. This can be done by taking a video or image sample similar to (or from) the type of data seen at source video 504 and evaluating its behavior at different scales. Additionally, per-class scaling parameters 564 may be determined by analyzing the data in which endpoint machine task system 556 is trained on. That is, it may be beneficial to identify the characteristics of objects in the training dataset. For example, a machine task system trained on a dataset with small objects may enable more aggressive scaling from the region transform module.

Area-based scaling offers an alternative solution to determining scaling factors for region boxes. In a class unaware scenario, the relative sizes of the extracted regions (and/or the sizes of the objects present within in region) may be used to perform scaling. For example, boxes which contain relatively large objects may be scaled more than regions with smaller objects.

Coding tree unit (CTU) aware methods may be employed to apply scaling in such a way that each frame may be encoded more efficiently. Scaling each of the region boxes to better align to coding tree units reduces the frame size while also optimizing the packed frame for encoding.

Rotation transformations may be applied to create optimal boxes for packing. This action may be performed on a per-region basis based on characteristics of the frame and the objects present. That is, boxes may be rotated in order to create better packed frames that can be encoded more efficiently.

Such region transformations aim to reduce the bits in the compressed bitstream 532 while also ensuring that machine task 252 (FIG. 2) system performance is improved or maintained. Table 1 compares the region packing system without any applied region transformations to a system which uses a class-based transformation method. Results show that such transformation methods boost overall pipeline performance. In this instance, the class-based technique significantly reduced the bits per pixel while also maintaining machine task performance.

TABLE 1
Region Packing System Results for Class Based Transformations
100% Resolution

| | Region Packing With No | | Region Packing With Class Based | | Original | |
|---|---|---|---|---|---|---|
| | Transformations Applied | | Transformations Applied | | Raw Source Frames | |
| QP | BPP | mAP | BPP | mAP | BPP | mAP |
| 22 | 0.620759418 | 0.80147 | 0.244575147 | 0.79717 | 0.841 | 0.80536 |
| 27 | 0.364342718 | 0.795638 | 0.149402141 | 0.783868 | 0.493 | 0.80197 |
| 32 | 0.206152411 | 0.781394 | 0.087252054 | 0.757763 | 0.277 | 0.78775 |
| 37 | 0.112577631 | 0.749274 | 0.048554303 | 0.701043 | 0.147 | 0.75653 |
| 42 | 0.059212221 | 0.687059 | 0.025960103 | 0.593743 | 0.074 | 0.69917 |
| 47 | 0.029979605 | 0.566119 | 0.013469565 | 0.432726 | 0.036 | 0.57773 |

| BD-rate | BD-mAP | BD-rate | BD-mAP |
|---|---|---|---|
| −11.12% | 0.901351102 | −35.15% | 4.161976578 |

### Region Packing

The transformed region box coordinates, returned from the transformation module 560, serve as input to the region packing system 520. The region packing module extracts the significant image regions and packs them tightly into a single frame. The region packing module 520 produces packing parameters that are preferably signaled in bitstream 532.

### Video Encoding

Packed object frames which contain the transformed regions from region transform module 560 are processed through video encoder 528 to produce a compressed bitstream 532. It will be appreciated that video encoder 528 can take the form of any suitable encoder known in the art for advanced compression standards such as AV1, HEVC, VVC, and the like and variants thereof. The compressed bitstream includes the encoded packed regions along with parameters 524 needed to reconstruct and reposition each region in the decoded and reconstructed frame. Original region sizes (i.e., those derived from inference 512, prior to region transform 560) are signaled in bitstream 132 for decoder side usage. Signaling may include providing data in a bitstream header, SPS, PPS, or supplemental information, such as SEI, and may vary depending on the CODEC standard in which the present systems and methods are deployed.

A decoder for decoding a bitstream encoded with the encoder of FIG. 5 is substantially the same as that illustrated in FIG. 2. The compressed bitstream 532 is decoded using video decoder 236 to produce a packed region frame along with its signaled region information in 240. Such region information 248 includes parameters needed for reconstruction of the frame. This includes any transformation information signaled from the transform module 560.

The decoded parameters 248 are used to unpack the region frames via region unpacking module 244. Each box is returned to its position within the context of the original video frame. The resulting unpacked frame only includes the significant regions determined by region detection system 512 and does not include the discarded pixels. Transformations performed by the transform module 560 are undone by complimentary processes in the unpacking stage. That is, each box is returned to its original size and orientation before being placed in the unpacked frame.

The unpacked and reconstructed video frame 248 is used as input to machine task system 252 which may perform tasks such as computer vision related functions. Machine task performance on the regions determined by the detection module 512 may be analyzed to determine optimal transformation parameters. Optimized region transformation parameters 564 may be updated and signaled to the pipeline in order to effectively apply transformations to the encoder-side region boxes.

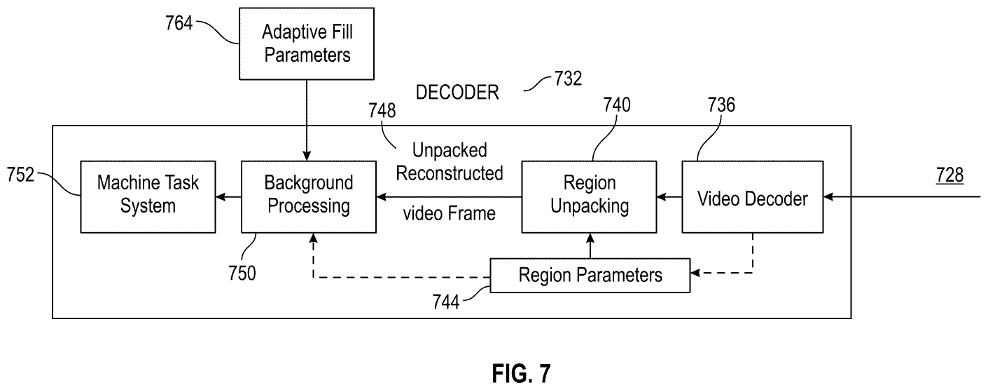

FIG. 7 is a block diagram of an alternate embodiment of a decoder in accordance with the present disclosure. The decoder 732 includes a video decoder 736 which receives the compressed bitstream 728, region unpacking module 740, and region parameters 744 which cooperate to generate unpacked reconstructed video frames 748. The decoder 732 further includes background processing module 750 which receives the unpacked reconstructed video frame as well as adaptive fill parameters 764. The background processing module 750 is coupled to the machine task system 752.

### Region Detection and Extraction

Referring back to FIG. 5, significant frame or image regions are identified using the encoder side region detector module 512, which produces coordinates of discovered objects. Saliency based detection methods using video motion may also be employed to identify important regions. Resulting coordinates are used to determine regions for packing and enable the identification of pixels deemed as unimportant to the detection module. Such unimportant regions may be discarded and are not used in packing. The region extraction module 516 extracts the image regions identified by 512 and prepares the coordinates to be used through the rest of the pipeline. The extraction module 516 may output additional parameters and regions to be encoded by video encoder 528. This may include a small patch, or patches, of background pixels to be later used in the unpacking module 740 (FIG. 7).

### Video Encoding

Packed object frames are processed through video encoder 528 to produce a compressed bitstream 532. The compressed bitstream includes the encoded packed regions along with parameters 524 needed to reconstruct and reposition each region in the decoded frame. Additional parameters may be signaled for use in decoder side 536 reconstruction processes such as signaling which pixels belong to the background and which pixels contain objects.

### Video Decoding

Returning to FIG. 7, the compressed bitstream 532 is received by decoder 732 and is decoded by video decoder 736 to produce a packed region frame along with its signaled region information in 748. This region information includes parameters needed for reconstruction of the frame along with any additional parameters incorporated to perform background transformation on the unpacked frames.

### Region Unpacking

The decoded parameters are used to unpack the packed region frames via region unpacking module 740. Each box is returned to its position within the context of the original video frame. The resulting unpacked frame 748 only includes the significant regions determined by the region detection system 512 and does not include the discarded pixels.

The background processing module 750 considers region parameters 744 along with any adaptive parameters 764 to apply further processing to the unpacked frame. Such further processing focuses on recreation of the discarded pixels from region detector 512. This includes application of different background filling techniques in order to provide more context for machine task system 752.

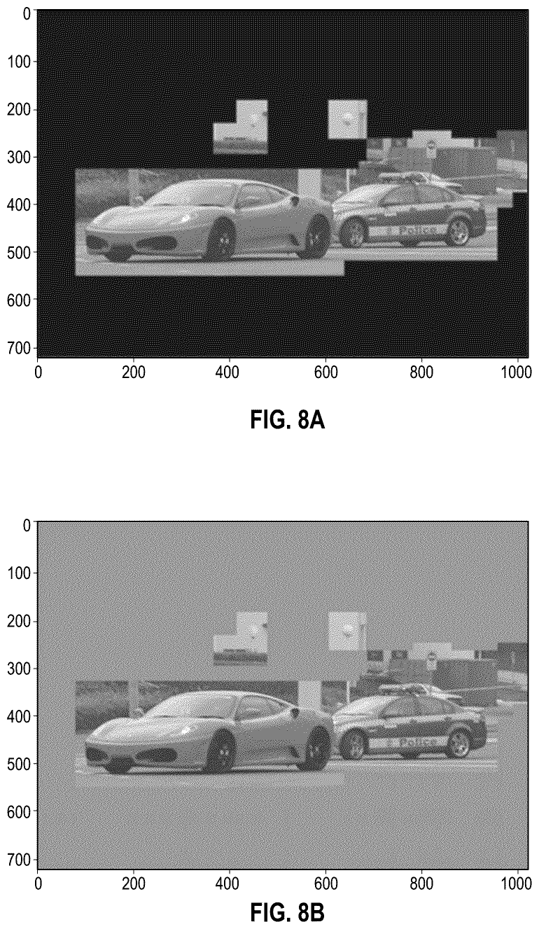

Referring to FIG. 8A, the default black background color in the unpacked frame may reduce machine task system performance. As shown in FIG. 8B, alternative background filling methods may use an average color of some (or all) of the pixels within the region boxes to create a new background in the unpacked frame. Background prediction techniques may also be applied such as inpainting in order to reconstruct background pixels. Optionally, bitstream parameters 744 may signal a specific fill color to be applied to the unpacked frame. Similarly, a specified patch of background pixels may be signaled in the bitstream and tiled across the black regions to create new background textures. Such transformations, applied to the unpacked frame, serve to provide additional context for machine related tasks performed by 752.

Background color may have an influence on machine task prediction and performance. Referring to FIG. 8A, using a black background in 804 may cause some false positive inference predictions to occur. False predictions may be minimized by replacing background pixels with an average background color as illustrated in FIG. 8B. Such false positive predictions may impact performance; thus, it is important to consider the sensitivity of such systems to background pixels and color.

### Machine Task

The unpacked and reconstructed video frame 748 is used as input to machine task system 752 which may perform machine tasks, such as computer vision related functions. Machine task performance on the unpacked frames which contain filled background may be analyzed and used to determine techniques for background filling on a per-frame basis. Optimized parameters 764 may be updated and signaled to the decoder side pipeline in order to effectively fill background pixels in unpacked frames.

In general, the processed frames of the methods disclosed herein are encoded using standard CODEC processes, such as VVC complying with VTM 12 encoding process. The CODEC may be modified to accept input region parameters as disclosed herein. Such region parameters are preferably included in the compressed bitstream and are decoded by the corresponding video decoder. The original bounding box dimensions and packed box dimensions are preferably recorded to track any applied transformations. Box parameters are defined as the original box coordinates produced by the Top-Down Extractor along with the corresponding packed positions. Box parameter coding may be improved by taking advantage of a block alignment process, such as a 16×16 block alignment, and CTU scaling, such that the encoded box dimensions and positions are in units of 16. The present implementation encodes parameters in a reduced form. Given box parameter p the reduced form p′ is defined as follows:

$${p}^{′} = ⌈ \frac{p}{16} ⌉$$

In some embodiments, box parameters (position and dimensions of the original and packed boxes) can be encoded in the slice header of a frame. The bitstream decoder retrieves the box parameters and decodes a packed frame. Box parameters are used to unpack and reconstruct the frames for machine processing.

Some embodiments may include non-transitory computer program products (i.e., physically embodied computer program products) that store instructions, which when executed by one or more data processors of one or more computing systems, cause at least one data processor to perform operations herein.

Embodiments may include circuitry configured to implement any operations as described above in any embodiment, in any order and with any degree of repetition. For instance, modules, such as encoder or decoder, may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Encoder 508 and decoder 732 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Non-transitory computer program products (i.e., physically embodied computer program products) may store instructions, which when executed by one or more data processors of one or more computing systems, causes at least one data processor to perform operations, and/or steps thereof described in this disclosure, including without limitation any operations described above and/or any operations decoder and/or encoder may be configured to perform. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, or the like.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

What is claimed:

1. An encoder for video for machine consumption comprising:
a region detector module, the region detector module receiving the source video and identifying regions of interest therein;
a top-down region extractor module, the top-down region extractor module receiving the identified regions of interest and generating a modified set of regions of interest that can be packed in a frame more efficiently, the modified regions of interest being defined at least in part by region parameters;
a region packing module, the region packing module receiving the modified set of regions of interest and packing the modified set of regions of interest into a packed frame in which pixels outside the modified regions of interest are substantially excluded; and
a video encoder receiving the packed frame and region parameters and encoding the packed frame and region parameters into a coded bitstream.

2. The encoder of claim 1, wherein the top-down region extractor module further comprises:
processing the detected regions of interest to form a union of regions of interest where at least one of adjacent and overlapping regions of interest are combined;
aligning the regions of interest from the union process to a predetermined grid;
slicing the aligned regions of interest along grid partitions;
reattaching slices to form modified regions of interest; and
providing coordinates of the modified regions of interest.

3. The encoder of claim 2, wherein the regions of interest are defined by a rectangular bounding box and wherein the region parameters include coordinates of the region bounding box within the source video frame.

4. The encoder of claim 2, wherein the predetermined grid is selected to align the regions of interest with boundaries of a coding tree unit in the packed frame.

5. The encoder of claim 2, wherein the predetermined grid is a 16×16 pixel grid.

6. The encoder of claim 3, further comprising a region transform module interposed between the top-down region extractor module and the region packing module, the region transform module, the region transform module receiving the coordinates of the modified regions of interest and applying at least one transform from the group including scaling, rotation, and translation on at least one modified region of interest, and providing coordinates of the transformed modified region of interest.

7. The encoder of claim 6, wherein the region transform module receives adaptive transformation parameters related to a machine process and applies a selected transform based in part on said parameters.

8. The encoder of claim 6, wherein the region transform module applies a transform based on at least one characteristic of the region of interest including, object confidence, object class, region area, or coding unit parameters.

9. An encoder for video for machine consumption comprising:
a region detector module, the region detector module receiving the source video and identifying regions of interest therein, the regions of interest being defined in part by coordinates of a bounding box in the frame of source video;
a region transform module, the region transform module receiving the coordinates of the regions of interest and applying at least one transform from the group including scaling, rotation, and translation on at least one modified region of interest, and providing coordinates of the transformed modified region of interest;
a region packing module, the region packing module receiving the set of regions of interest and transformed regions of interest and arranging the regions of interest into a packed frame in which pixels outside the regions of interest are substantially excluded; and
a video encoder receiving the packed frame and coordinates of the regions of interest and encoding the packed frame and region parameters into a coded bitstream.

10. The encoder of claim 9, wherein the region transform module receives adaptive transformation parameters related to a machine process and applies a selected transform based in part on said parameters.

11. The encoder of claim 9, wherein the region transform module selectively applies a transform to a region of interest based on at least one characteristic of the region of interest, including at least one of object confidence, object class, region area, or coding unit parameters.

12. A method for encoding a source video for machine consumption comprising:
receiving the source video and identifying regions of interest therein;
processing the detected regions of interest to form a union of regions of interest where at least one of adjacent and overlapping regions of interest are combined;
aligning the regions of interest from the union process to a predetermined grid;
slicing the aligned regions of interest along grid partitions;
reattaching slices to form modified regions of interest;
providing coordinates of the modified regions of interest;
receiving the modified of regions of interest and arranging the modified set of regions of interest into a packed frame in which pixels outside the modified regions of interest are substantially excluded; and
encoding the packed frame and region parameters into a coded bitstream.

13. The method of claim 12, further comprising receiving the coordinates of the modified regions of interest and applying at least one transform from the group including scaling, rotation, and translation on at least one modified region of interest, and providing coordinates of the transformed modified region of interest.

14. A decoder for decoding an encoded bitstream having a packed frame of regions of interest, the decoder comprising:
a video decoder, the video decoder receiving the encoded bitstream and decompressing the bitstream to identify regions of interest and region parameters therefrom;
a region unpacking module, the region unpacking module receiving the decoded packed frame and region parameters and arranging the decoded regions of interest in a reconstructed frame with size, position and orientation corresponding to the original frame, the pixels in the reconstructed frame outside the arranged regions of interest being background pixels;
a background processing module, the background processing module setting a parameter of the background pixels to optimize performance of a machine task system receiving the reconstructed frame.

15. The decoder of claim 14, wherein the background processing module receives at least one adaptive fill parameter, the adaptive fill parameter indicating a performance metric of the machine task system based on at least one parameter of the background pixels.

16. The decoder of claim 15, wherein the parameter of the background pixels is a fixed color.

17. The decoder of claim 15, wherein the parameter of the background pixels is an average color of the pixels in the regions of interest.

18. The decoder of claim 15 wherein the adaptive fill parameter indicates a parameter of the background pixels in which object detection by the machine task system is optimized.
